(19) United States
(12) Patent Application Publication
(10) Pub. No.: US 2008/0246266 A1
(43) Pub. Date: Oct. 9, 2008

(54) Torsion Bar For Application In Belt Winders For Safety Belts

(75) Inventors: Siegfried Oesterle, Dornbirn (AT); Ernst Sieber, Diepoldsau (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS INTEC HOLDING AG, HEERBRUGG (CH)

(21) Appl. No.: 10/574,735

(22) PCT Filed: Dec. 6, 2004
(86) PCT No.: PCT/EP04/53276

§ 371 Date: Apr. 5, 2006

(30) Foreign Application Priority Data
Dec. 11, 2003 (DE) 10357979.6

(51) Int. Cl. B60R 22/28

(52) U.S. Cl. 280/805

(57) ABSTRACT

The invention relates to a torsion bar (1), for application in belt winders for safety belts, provided on the end sections thereof with embodiments of drive and/or locking elements (2, 3), for positive connection to corresponding devices. The torsion bar (1) and the drive and/or locking elements (2, 3) provided on the ends thereof is produced in one piece from a non-ferrous metal, using varying impact extrusions in order to achieve different torques with constant dimensions or the drive and/or locking elements (2, 3) with various diameters for the torsion bar (1).

### BACKGROUND

The invention relates to a torsion bar for application in belt winders for safety belts, provided on the end sections thereof with embodiments of drive and/or locking elements for positive connection to the corresponding devices.

A number of embodiment variations of torsion bars have become known, all of which are made from steel and steel alloys in a cold forming processes. Due to the fact that the torsion bars between the drive and/or locking elements have to be produced in various diameters according to the requirements of the torsion behavior, and the strain during a cold forming process only allows certain diameter ratios between the torsion bar and the drive and/or the locking elements, it was generally unavoidable to perform metal cutting manufacturing, in addition to the cold forming process, in order to allow the production of considerably smaller diameters of the torsion bar in spite of consistent diameters of the drive and/or locking elements.

Additionally, in torsion bars there are hard to solve problems in low temperature behavior of the torsion bar material made from common steel, i.e. the torsion bars break much too easily. The requirement of the automobile industry for low temperature function already exists, namely at least 5.5 rotations at −35° C. Here, additional problems arise in torsion bars made from steel when they were produced in a cold forming process.

### SUMMARY

The invention is to attain the objective of providing a torsion bar for application in belt winders produced in one piece with their end sections being embodied with drive and/or locking elements, fulfilling the requirements according to the low temperature function and additionally being produced without any metal cutting manufacturing.

This is attained according to the invention in that the torsion bar including the drive and/or locking elements embodied at its end for achieving various torques at constant sizes of drive and/or locking elements and various diameters of the torsion bar is produced in one piece in a cold forming processes from a non-ferrous metal using various impact extrusions.

By these measures according to the invention, the problems in pressing technology can be solved easily because the adjustment of the diameters of drive and/or locking elements and torsion bars is possible using the different extrusion behaviors of various materials. Therefore, an adjustment has been possible to the extent that the final product can be produced without any metal cutting manufacturing.

Further advantages result from essential weight savings being possible, perhaps. Furthermore, no protection from corrosion is required. Depending on the non-ferrous metal to be used, the tool life can be improved considerably in the cold forming process used for the production of torsion bars.

With regard to the drive and/or locking elements, predetermined dimensions are given. The adjustment of the diameter of the torsion bar by means of pressing technology has been achieved by the use of non-ferrous metals. Here, it is not simply an exchange of material, but a number of inventive steps were necessary, in order to achieve the possibility in cold forming processes allowing the diameter ratios to be adjusted to one another and in order to even find a material that can be cold formed in such dimensions, which additionally provides the required torques in the area of the torsion bar and also in the area of the drive and/or locking elements.

Further, it is provided that at the drive and/or locking elements formed at the ends have exterior dimension equal or larger than the torsion bar itself. By the material used according to the invention a very small difference in diameters is possible, too, so that the cold forming production can be used optimally.

A particularly beneficial embodiment is provided when the torsion bar, produced in a cold forming process, is made from aluminum. Aluminum has approximately the same extrusion behavior as unannealed steel. However, a strength behavior under torsion can be achieved, here, which is possible in steel at very small diameters only. Then the extrusion behavior of steel is a hindrance for using a cold forming process. Namely, metal cutting manufacturing must be performed thereafter. This can be avoided entirely with aluminum because the differences in diameters between the torsion bar and the drive and/or locking elements can be kept small.

The optimum plasticity for the production of a torsion bar is provided when pure aluminum is used up to 99.5% by Vol. purity. The extrusion behavior of almost pure aluminum is particularly suitable for the production of a torsion bar in a cold forming process.

Due to the good deformability and the extrusion behavior of non-ferrous metals, here, in particular aluminum or copper, for example, it has also become possible in a simple manner for the torsion bar to be provided cylindrical or prismatic.

By the optimum production possibilities using the particularly adjusted material it is even easier to create different constructive variants of the torsion bar and the drive and/or locking elements as well. Therefore, it can be provided for the drive and/or the locking elements to be provided as toothed wheels or to be provided with catch elements having flattenings.

In this context it has also become possible for a transfer between the drive and/or the locking elements and the torsion bar to be provided in the form of a conical section or a flute. Therefore, by the use of a non-ferrous metal and, in particular, a light metal such as aluminum, ideal constructive embodiments with optimum torsion behavior as well as optimum transfer of force can be achieved in the drive and/or locking elements.

### BRIEF DESCRIPTION OF THE DRAWINGS

In the following description, additional features and particular advantages of the invention are explained in greater detail using the drawing:

FIG. 1 shows an example of a torsion bar provided with drive and/or locking elements embodied at the ends thereof.

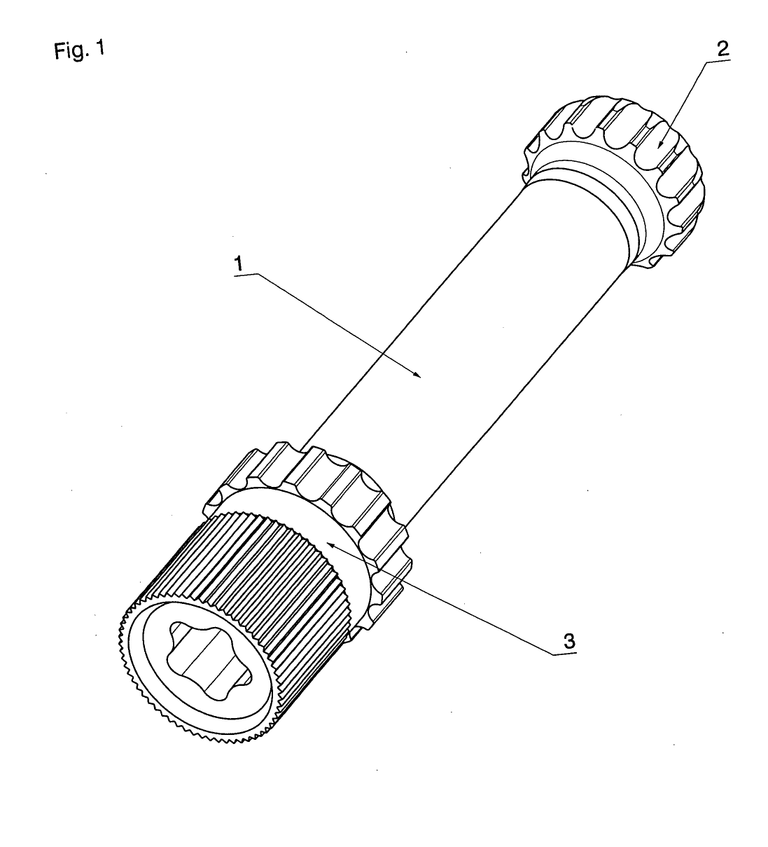

### DETAILED DESCRIPTION OF THE PREFERRED EMBODIMENTS

The torsion bar 1 shown serves for use in belt winders for safety belts. At its end sections, drive and/or locking elements 2 and/or 3 are provided, which can be coupled with respective devices in order to allow a single or multiple rotations of the torsion bar under particular stress of the safety belt and thus to act as a type of shock absorber. The torsion bar 1 including the drive and/or locking elements 2 and/or 3 embodied at the ends thereof are produced in one piece from a non-ferrous metal in a cold forming process using various impact extrusions in order to achieve various torques with constant sizes of the drive and/or blocking elements and various diameters of the torsion bar.

The drive and/or locking elements 2 and/or 3 located at the ends are provided with equal or larger exterior dimensions than the torsion bar 1 itself.

According to the present invention, the term non-ferrous metals essentially defines light metals and copper or copper alloys. Among the non-ferrous metals, copper, for example is a suitable material. Among the light metals, in particular aluminum is advantageous for producing a torsion bar in a cold forming processes. Here, it is advantageous when aluminum is used with up to 99.5% by Vol. purity.

With respect to construction, considerable improvements have become possible by the newly used materials. The torsion bar 1 can be constructed, for example, cylindrical or prismatic. The drive and/or locking elements 2 and/or 3 can be provided as toothed wheels or as catching elements provided with flattenings. A transfer 4 in the form of a conical section or a flute can be provided between the drive and/or the locking elements 2 and/or 3 and the torsion bar 1.

Within the scope of the invention additional embodiments are possible, of course, which result from the use of non-ferrous metals, and here particularly aluminum, for the production of torsion bars in a cold forming process. Therefore, the requirements of the automobile construction for low temperature behavior of the torsion bar material can be fulfilled in an optimum manner.

1. A torsion bar for application in belt winders for safety belts, comprising a bar having on end sections thereof drive and/or locking elements for positive connection to respective devices, the drive and/or locking elements (2, 3) embodied at the end sections for achieving different torques at constant sizes of the drive and/or locking elements (2, 3) and varying diameters of the torsion bar (1) is produced in one piece in a cold forming impact extrusion process from a non-ferrous metal.

2. A torsion bar according to claim 1, wherein the drive and/or locking elements (2, 3) at the ends thereof have equal or larger exterior dimensions than the torsion bar (1) itself.

3. A torsion bar according to claim 1, wherein the torsion bar (1) is made from aluminum in a cold forming process.

4. A torsion bar according to claim 2 wherein the aluminum has a 99.5% by Vol. purity.

5. A torsion bar according to claim 1, wherein the torsion bar (1) is cylindrical or prismatic.

6. A torsion bar according to claim 1, wherein the drive and/or locking elements (2, 3) are provided as toothed wheels or as catching elements provided with flattenings.

7. A torsion bar according to claim 1, wherein a transfer section (4) is provided having a conical section or a flute between the drive and/or the locking elements (2, 3).
